(19) United States
(12) Patent Application Publication
(10) Pub. No.: US 2006/0247965 A1
(43) Pub. Date: Nov. 2, 2006

(54) Method of defining and monitoring processes

(76) Inventors: Wm. Patrick Griffith, Angwin, CA (US); John Donald Thomson, Vancouver (CA)

Correspondence Address: WELSH & KATZ, LTD, 120 S RIVERSIDE PLAZA, 22ND FLOOR, CHICAGO, IL, 60606, US

(21) Appl. No.: 11/118,549

(22) Filed: Apr. 29, 2005

(51) Int. Cl. G06Q 99/00; G05B 19/418; G06F 15/02; G06F 9/46

(52) U.S. Cl. 705/9; 705/8; 705/1

(57) ABSTRACT

A method and apparatus for defining and monitoring a process of an organization. The method includes the steps of forming a plurality of control templates that define resource use requirements of the organization, identifying at least one control template of the plurality of control templates associated with the process, identifying resources of the process, defining a schedule of events of the process that delineates application of the identified at least one internal control to the identified resources and defining and monitoring the schedule of events for completion of the process in compliance with the identified at least one internal control.

### FIELD OF THE INVENTION

The field of the invention relates to organizations and more particularly to methods of defining and monitoring processes within organizations.

### BACKGROUND OF THE INVENTION

The need for modeling business operations is generally understood. In small businesses, where the business is managed by a small number of people the rules of the operating model may be quite simple.

Such models may be easily complied with because a single person may perform every step in the process. However, in larger organizations, any one process may have many people involved. In addition, many business processes can be inter-related. For example, data collected about operation of one part of a business may be used in many different processes of the business.

A great deal of effort has been expended over the years, in defining, measuring, re-engineering and automating business processes in a broad range of industries. The overriding objective in each instance has been to improve operational efficiency through increased productivity and automation. Traditional automation solutions have used workflow models to define business process. These workflows are described as linear, with a beginning and ending point. In between is a defined pathway for completing the work assignment. This model is good for determining efficiency; however, it is not the optimal way for determining process effectiveness, which is what executives need to know to base their decisions.

In addition, executives are not as concerned with the specific workflows of a business process, because the workflow does not indicate operational effectiveness. As such, the workflows of the thousands of business processes running within an organization often compound the inability to determine overall effectiveness. Because each business process may be a uniquely defined entity, current automation solutions cannot provide a comprehensive view into overall business process effectiveness. Today, executives do not have a universal business process language that allows them to define and monitor for determining organizational effectiveness. The end result is a lack of information to make informed decisions based on the effectiveness of the business processes driving organizational operation.

As business automation becomes more comprehensive, the ability to define and explain a business process has become more difficult. Further complicating this is the changing nature of organizations. Business process is no longer confined to a specific entity within an organization. Responsibility for managing processes cuts across traditional organizational hierarchies. The eventual effectiveness of a business process may be dependent on multiple entities with an organization. As a result, many organizations are using the definition of business process to support the definition of organizational boundaries.

At the same time, the functions of business processes have become more specialized, and the knowledge to control such processes more localized within a few specialists. The result has been an increase in the opportunity for accounting irregularities and also in the occurrence of a number of spectacular business failures in recent years.

The Sarbanes-Oxley Act of 2002 has mandated better methods of controlling and reporting on business operation. In this regard, internal controls always have been and always will lie at the foundation of any corporate governance effort. However, there are no easy methods of providing better control with existing technology. Accordingly, a need exists for better tools that define and then monitor corporate operation.

### SUMMARY

A method and apparatus for monitoring a process of an organization. The method includes the steps of forming a plurality of process and control templates that define resource use requirements of the organization, identifying at least one control template of the plurality of control templates associated with the process, identifying the requirements and resources of the process, defining a schedule of events of the process that delineates application of the identified at least one internal control to the identified resources and monitoring the schedule of events for completion of the process in compliance with the identified at least one internal control.

### BRIEF DESCRIPTION OF THE DRAWINGS

FIG. 1 is a block diagram of a processing monitoring system in accordance with an illustrated embodiment of the invention;

FIG. 2 is a dashboard display that shows a summary of processes operating within the system of FIG. 1;

FIG. 3 is a menu screen that may be used by the system of FIG. 1;

FIG. 4 is a search processes screen that may be used by the system of FIG. 1;

FIG. 5 is a process list screen that may be used by the system of FIG. 1;

FIG. 6 is a process wizard screen that may be used by the system of FIG. 1;

FIG. 7 is a reports menu screen that may be used by the system of FIG. 1;

FIG. 8 is a process templates screen that may be used by the system of FIG. 1;

FIG. 9 is a blank process templates screen that may be used by the system of FIG. 1;

FIG. 10 is a summary process templates screen that may be used by the system of FIG. 1;

FIG. 11 is a risk details screen that may be used by the system of FIG. 1;

FIG. 12 is a contingencies screen that may be used by the system of FIG. 1;

FIG. 13 is a contingencies selection screen that may be used by the system of FIG. 1;

FIG. 14 is a internal controls templates screen that may be used by the system of FIG. 1;

FIG. 15 is a internal control summary screen that may be used by the system of FIG. 1;

FIG. 16 is a test templates summary screen that may be used by the system of FIG. 1;

FIG. 17 is a test templates entry screen that may be used by the system of FIG. 1;

FIG. 18 is a resource assignment screen that may be used by the system of FIG. 1;

FIG. 19 is an events assignment screen that may be used by the system of FIG. 1;

FIG. 20 is a resource assignment screen that may be used by the system of FIG. 1; and

FIG. 21 is a documents attachment screen that may be used by the system of FIG. 1.

### DETAILED DESCRIPTION OF AN ILLUSTRATED EMBODIMENT

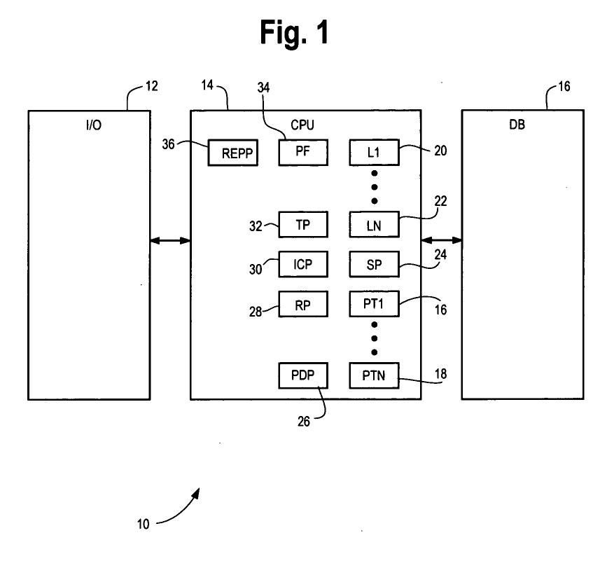

FIG. 1 is a simplified block diagram of a system 10 for modeling business processes shown generally in accordance with an illustrated embodiment of the invention. The process governance architecture of FIG. 1 is an innovative departure from traditional business process definition and automation for a number of reasons. For example, traditional process definition methods utilize a linear method to uniquely define each process at the transaction workflow level. This makes control, monitoring and communication at the enterprise level expensive and complex. One objective of the architecture of the system 10 is to find a simpler, more universal way of defining processes without giving up the individual process characteristics that enable control and execution.

The system 10 defines processes within an enterprise process hierarchy, grouping all processes into three types (routines, projects, and action items), which share the same four sets of variables (requirements, resources, schedules, risks-and-contingencies) and common sets of relationships. By using the process hierarchy instead of traditional linear-based workflows, the system 10 incorporates universal relationships and rules that eliminate the need to uniquely define every component and every rule of every process. The entire enterprise process structure can be defined and managed to provide automated control and communication, making it easier for anyone to understand and manage the process and governance environment.

A set of process templates 16, 18 are at the core of the functionality of the system 10. Process templates enable any enterprise using the system 10 to standardize how specific processes are to be performed, while providing almost infinite levels of user flexibility. The amount of flexibility can vary significantly based on corporate standards and user needs. This is particularly important when the same basic process, e.g. a quarterly assessment or audit, can change slightly or significantly from one period to another.

The specific characteristics of the unique hierarchy-based methodology of the system 10 can be described in terms of business processes and variables. In general, there are only three types of business processes: 1) routines, 2) projects and 3) action items.

With regards to variables, there are four distinct sets of variables that define any process. The first variable is Requirements. Requirements define all requisite components of a process, e.g. internal controls, inputs, outputs, policies, procedures, and process deliverables. Requirements also include the other variables at the definitional level, e.g. human and other resources, schedule of process steps and the definition of risks and contingencies.

The second variable is resources. Resources are applied to a process in specific quality and quantity to execute the requisite steps of the process.

The third variable is the schedule of events. The schedules consist of all events, tasks and work elements necessary to complete the process. Critical to schedule is the specific order or “flow” of the schedule components.

The fourth variable is risks and contingencies. Risks define all negatives that can impact the expected and successful execution of a process. Contingencies are the predefined resolutions of a risk occurrence. A risk may have multiple contingency options, and contingencies can be a simple statement of correction or an elaborate, executable process.

Each set of variables has specific relationships with its process and with the other sets of variables that enable the process to be uniquely defined without compromising the process types or the parameters of the four variables. Regardless of the detail or terminology used by a business, all process factors can be aligned within one of the variable sets, simplifying the definition, control and communication.

Supporting these variable relationships are a number of libraries 20, 22. The libraries contain specific detail components that make process definition unique and administration definitions that provide additional components to provide template and process detail.

Process definition and relationships will be considered next. As the user creates and defines the process relationships, the universal rules to control and communicate those relationships are automatically applied. The user can quickly link a process into the enterprise process hierarchy by process ownership and sponsorship. Processes can be easily moved and re-linked without redefinition. The level of detail to define or manage any process is wholly at the user's discretion. This is especially important in developing a comprehensive corporate governance framework, where companies in certain industries, such as financial services, face multiple corporate governance mandates that share requirements and internal controls across common process and systems.

For example, when a user defines a process template within the system 10 (which can be used many times without redefinition) the user automatically has access to: 1) templates, 2) relationships and extensions for the process variables, 3) links to attach controls, risks, contingencies, documents, assignments and more.

The process templates may be subroutines that are defined in the administrative definitions of the system 10 to ensure their maximum control. Each process template is available to any user authorized by role to create processes. Each process template is defined according to one of the basic process types: 1) Routine, 2) Project, 3) Action Item and Contingency (a special form of Action Item). The user builds a process template within one of these types, thus creating a unique process sub-type.

This entire structure is part of the basic template. However, the user is not required to add variables or attachments for all components. A process template may be defined as a shell or a placeholder in the Process Hierarchy. As such, it will be used for summarization and reporting purposes, and for defining the process hierarchy in terms of the enterprise, organization and management structure.

A process may be created by opening a process file 34 and saving process template to that file. The saved process template may be expanded by the events and tasks that are specific to the process. Pre-existing process components may be attached to these events and tasks as program objects to detect the occurrence of these events and tasks and to report on their successful completion and the successful completion of the process.

Many of the process components are added simply by selecting them from existing libraries and administrative definitions. Components can be added at multiple levels within the process template or the created process.

Events and Tasks are the only components that are created within the process template and are totally unique to the defined process. Events and their tasks can be created as “required” or “optional,” adding to the flexibility of the template and process. Tasks can be created and added into the actual process after it is created from a process template. However, tasks can only be created within an existing Event. (Events and Tasks will be discussed later in this Section.) The next section describes how to define and edit a new process template. The remaining sections will define and edit the Variables and Attachments.

A process template is a re-usable model to standardize a specific process or sub-type of process across the enterprise to ensure consistency and reliability of execution and results.

In effect, the events and tasks of the process file 34 form a roadmap (i.e., a sequence) that defines the process and that is followed by a sequence processor 24 that tracks the state of the process. Other processing entities may be attached to the process defined within the process file 34 as further program objects and that report on various aspects of the process. For example, a Risk Agent operating on a risk processor 28 may monitor the whole process or certain events of the process and report on the occurrence of the risk event to the process owner. Upon the occurrence of the risk event, the risk agent 28 may prompt the process owner as to the availability of process contingencies and to execute those contingencies.

Similarly, internal controls operating on an internal control processor 30 may be attached to the process, individually or by group. Tests operating on a test processor 32 may be attached to each internal control to prompt an assigned resource of the organization to monitor and assess the results of the internal controls.

The system 10 is designed to manage the enterprise governance issues by defining, integrating and managing necessary process data and functions at the enterprise level. Therefore, it is important that processes, and particularly business processes, are defined to the extent governance automation is required.

The system 10 provides the ability to expand the basic process template and processes created from the template by the addition of 6 categories of Variables and Attachments. There are 3 sets of Variables attached directly to the process: 1) internal controls (a subset of requirements), 2) risks and 3) events. Each of these has its own extensions, variables and attributes, which are discussed below.

There are also 3 sets of Attachments within the process: 1) punchlists, 2) documents and 3) notes. Attachments are intended to augment the information in the process and its variables. Punchlist items actually initiate system activity and are monitored by the system 10, creating certain automatic status changes and notifications. Punchlists can be integrated with email and text messaging.

When the template is used to create an actual process, all of the variables and attachments of the template are copied over to the process by a process definition processor 26. They can, again, be modified or deleted within certain limits, which vary within the variable and attachment types.

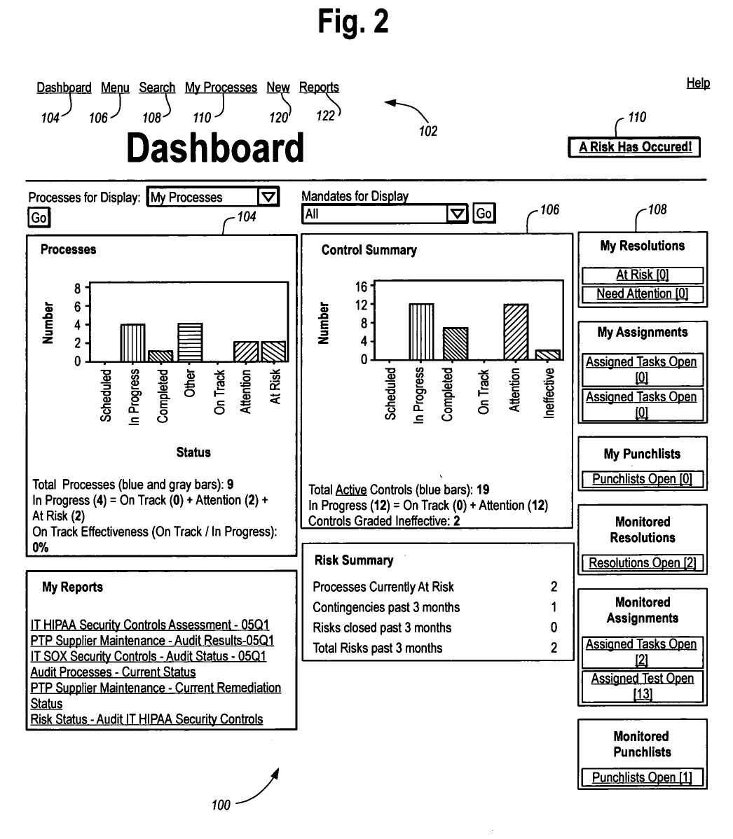

FIG. 2 shows a control screen 100 of the system 10 referred to as the process dashboard. Shown along a top edge of the screen is a series of soft keys 102 that allow access to the features of the system 10.

Also shown in FIG. 2 are a number of summary windows that show the status of processes controlled or accessed by the user (process owner). For example, a first window 104 may show the number and status of processes owned by the user. A second window 106 may show a list of all processes accessible by the user and monitored by the system 10. A third window 110 may give indication of non-compliant processes and a fourth window 108 may give indication of those processes needing attention to bring the processes back into compliance.

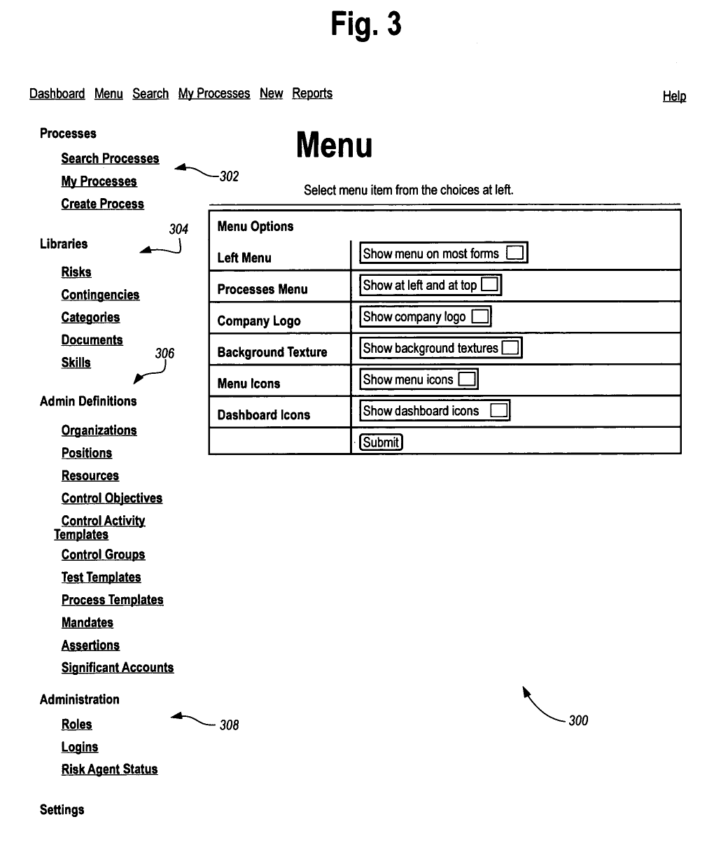

If a user should activate the menu soft key 106, then the menu screen 300 of FIG. 3 may appear. The menu screen 300 may be used to control menu presentation within the other control screen used by the system 10 to improve speed and efficiency for the experienced user.

Shown along the left side of the menu screen 300 may be a number of function control menus 302, 304, 306, 308. The processes menu 302 may be used to find or create new processes. A libraries menu 304 may provide access to a set of documents that may be used with processes created through the processes menu 302. An administrative definitions (admin definitions) menu 306 (described in more detail below) may provide a repository of pre-existing templates and definitions that may be used in processes created through the processes menu 302. A user administration menu 308 may be used to control access to the system 10.

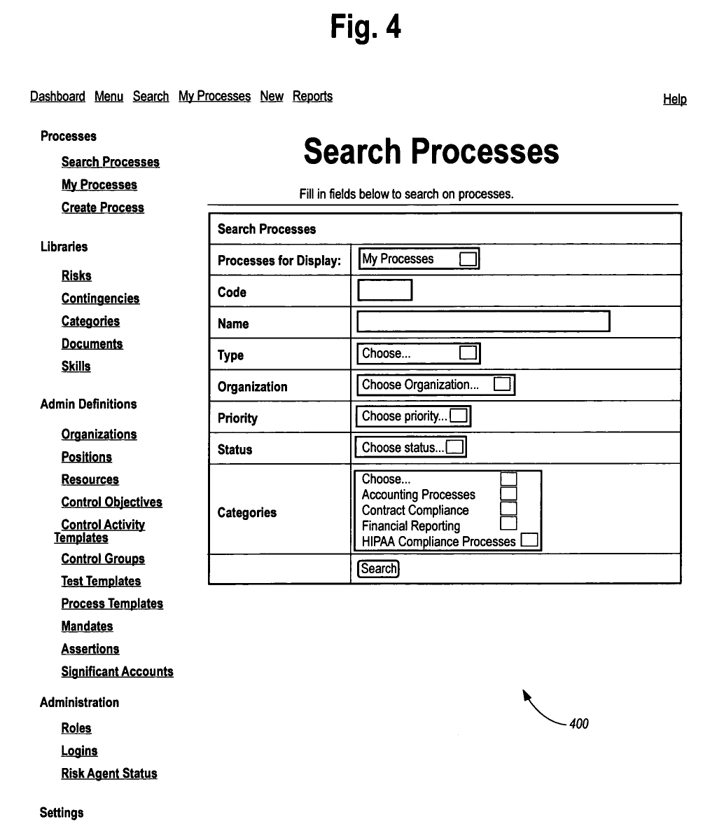

Activation of the search soft key 108 shown on the dashboard 100 or menu screen 300 may provide a search processes screen 400 of FIG. 4. The search processes screen 400 may allow a user, based on role and access rights, to search for processes under any of a number of different criteria (e.g., name, code, organization, etc.).

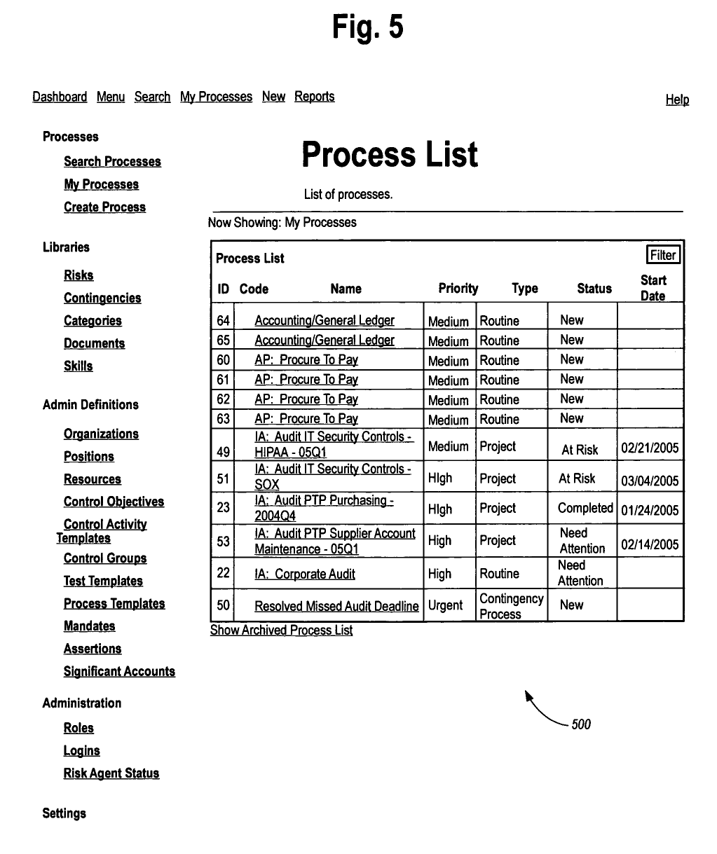

Activation of the “My Processes” soft key 110 may provide the user with a list (FIG. 5) of currently owned processes. The list may include an ID code, a name, a priority, a type, a status and a start date. Processes in the list provide drill-down hyperlinks to their process details, variables and attachments.

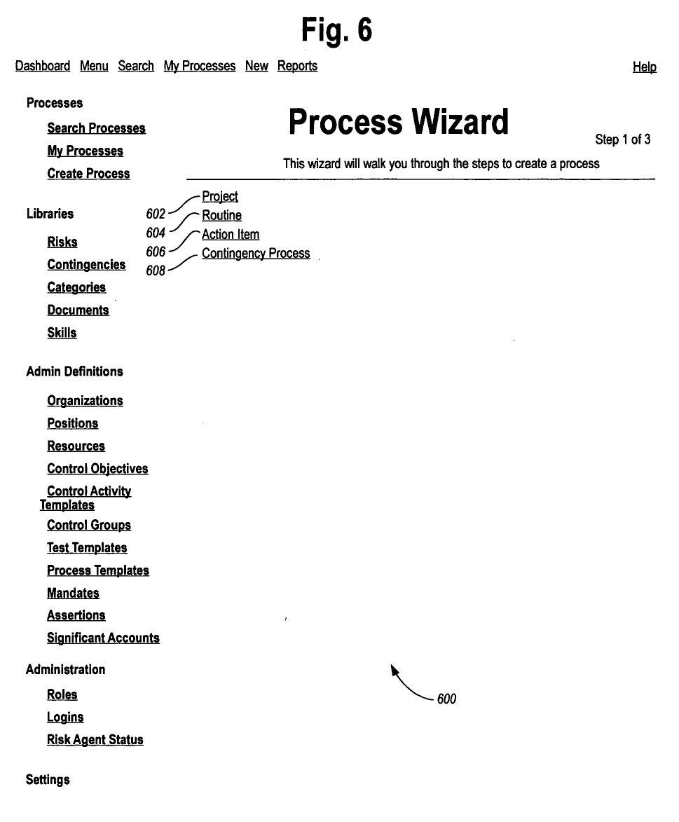

Activation of the “New” soft key 120 provides the user with the process wizard screen 600 of FIG. 6. Shown on the screen 600 may be a softkey 602, 604, 606, 608 that may be used to initiate the creation of any of a number of different types of new processes from existing process templates.

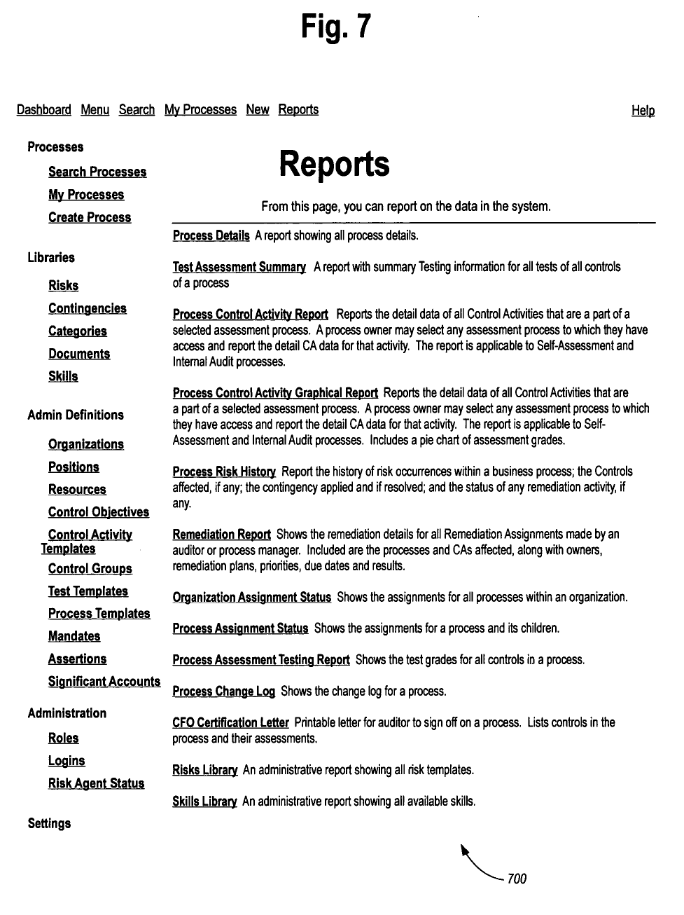

Activation of the “Reports” soft key 122 may cause the report selection screen 700 of FIG. 7 to be presented to the user. As shown in FIG. 7, any of a number of different reports may be created for the user, many of which are parameter-driven, expanding report filtering and detail.

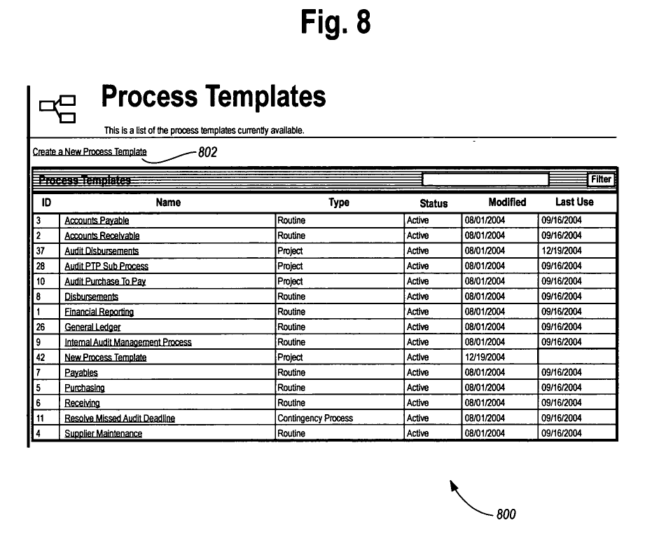

Examples will now be provided of the use of the system 10 in creating process templates in a process hierarchy. In this regard, FIGS. 3-7 show the admin definitions (resources) screen 306. Admin definitions provide the information and variable baseline for creating and then managing processes in the system 10. The Admin Definition navigation bar 306 allows users to create new templates for processes, internal controls and templates as well as other definitions that allow the user to uniquely define the template. Admin definitions manage templates as well as specific definitions used at the process and internal control level. To begin creating a process, a user may first select the “Process Templates” soft key from the admin definitions menu 306. Activation of the process templates soft key causes the process definition processor 26 of the system 10 to open a new process file 34 and to present the user with the screen 800 of FIG. 8. Using the screen 800, a user can create a new process from an existing process template or create an entirely new process template.

Shown in FIG. 8 is a number of pre-existing process templates. As may be noted, at least some of the pre-existing templates are general ledger, some are receiving, some are purchasing.

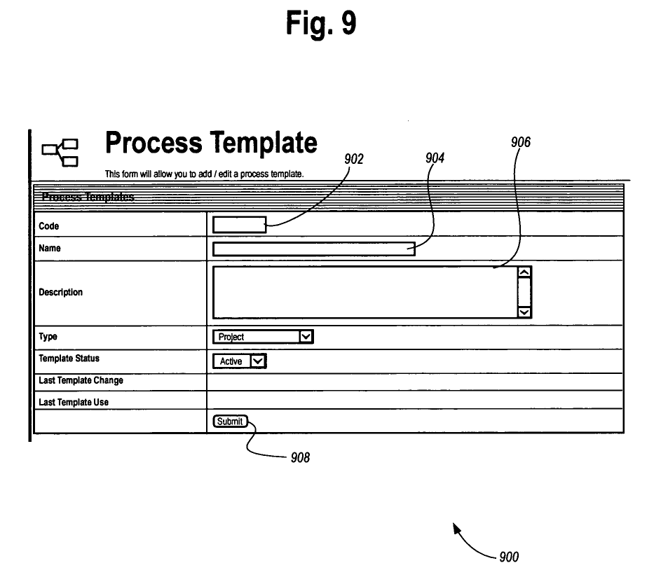

To access a process template, the user may place his cursor over and click on (i.e., select) one of the listed templates or activate the “Create New Process Template” template softkey 802. Activation of the Create New Process Template softkey 802 may cause the screen 900 of FIG. 9 to appear on the display of the user.

The initial template 900 contains only information that defines the template at the process level. Most important is the template type, which identifies the process as one of the three process types in the process hierarchy or as a contingency process, which is then used to resolve risk.

The user may enter a code in a first window 902, a name in a second window 904 and a description in a third window 906. Once identifying information has been entered, the user may activate a submit softkey 908.

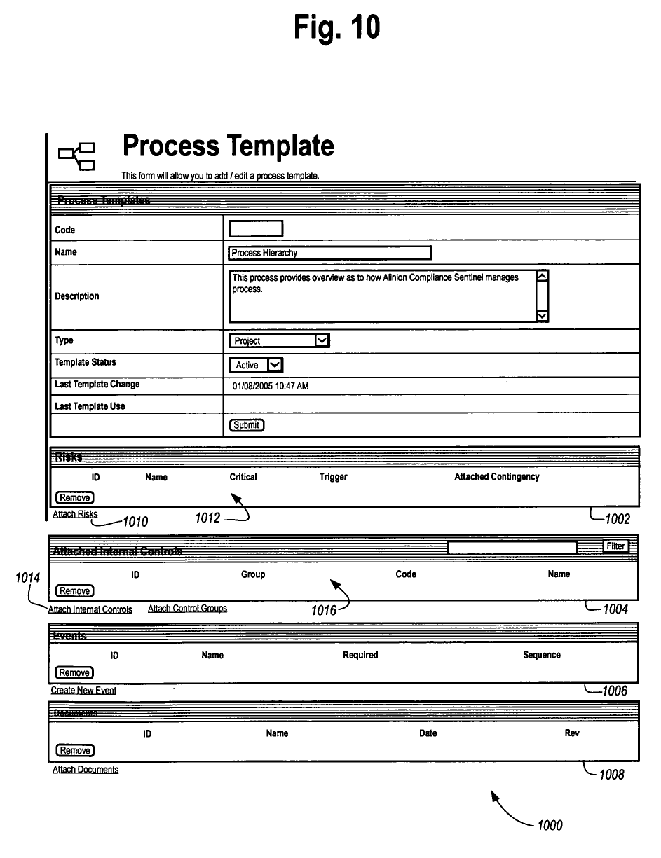

Once the template 900 is submitted (or the user had clicked on one of the pre-existing processes of FIG. 8), the program definition processor 26 may add the defined process template to the process template file 34 as a program object. The program definition processor 25 may also cause a summary screen 1000 (FIG. 10) to be presented, with the process template windows of the variables which affect the process effectiveness or outcome. The process template windows of the variables are the risks 1002, the internal controls (requirements) 1004, events 1006 and documents 1008 supporting the process template definition and processes created from this template. Risks and documents are chosen from libraries 304; while control tests, because they are template based, are chosen from administrative definitions 306. Required and optional events and tasks are created directly in and are unique to the process template. Risks and documents are available for attachment to the process template via the library function, as described in more detail below.

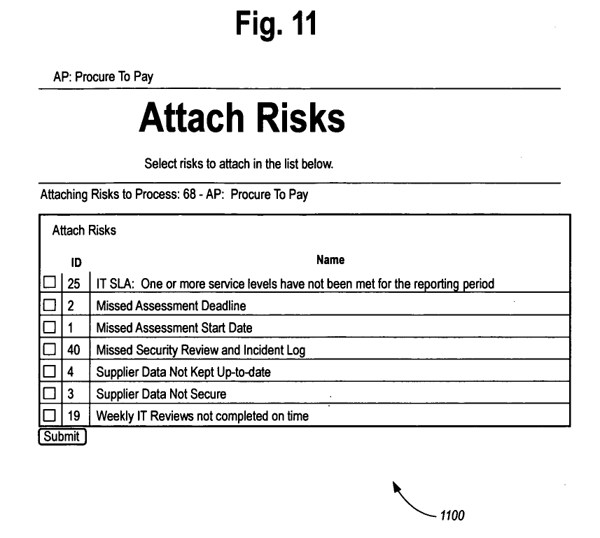

The user may attach a risk variable to the process template by activating an attach risks softkey 1010. In response, the screen 1100 of FIG. 11 is presented to the user. The user may check the box adjacent to each risk that applies to this process template.

Risks are chosen from the risk library. The Risk is attached at the template level. Once the user has selected any risks (by checking the appropriate box), the user may activate a submit softkey to add the selected risks to the process file 34 as further program objects. The selected risks may then be caused to appear within a risks list area 1012 of the window 1002. Risks become fully active when a process is created from the process template.

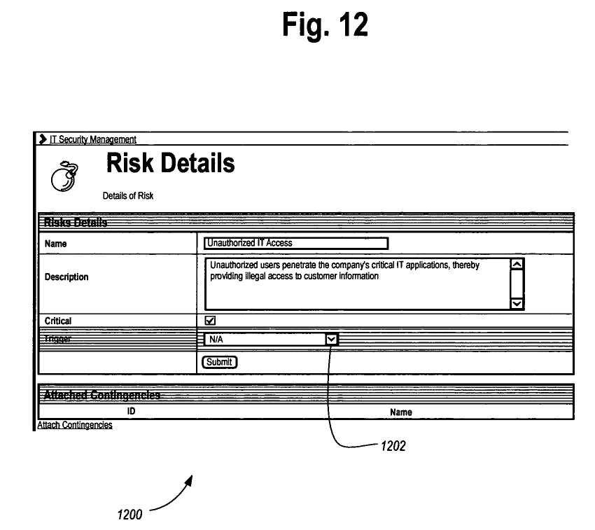

The user may also attach a contingency template to any risk, which is a form of process in the system 10. To attach contingencies, the user may click on any risk appearing within the risk list area 1012. In response, the risk detail screen 1200 of FIG. 12 may appear. On this screen 1200, the user may activate the attach contingencies softkey (FIG. 12).

Contingencies provide a standard methodology for resolving risks. Contingencies are pre-defined for each process using data stored in the Admin Definitions. Contingencies contain tasks which are assigned to resources identified in the system.

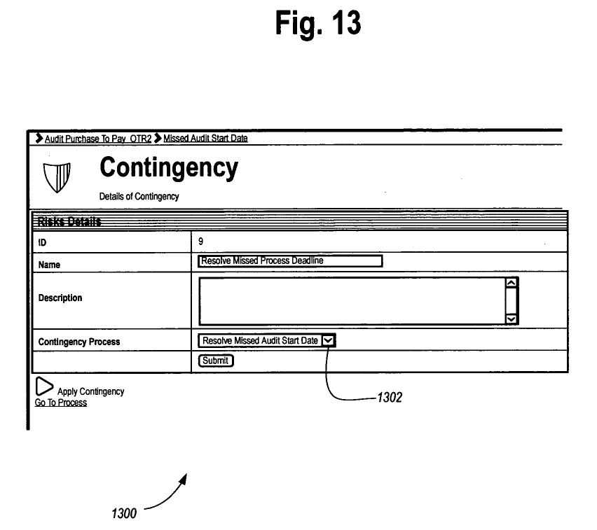

Upon activating the “attach contingency” softkey on the risk detail screen 1200, the screen of FIG. 13 may appear. A contingency may be selected and then attached as a further program object to the risk. The contingency may be selected by activating a pull-down menu 1302 and selecting a contingency.

The user may then activate the submit softkey to add the contingency to the file 34 and return to the risk screen 1200. Within the risk screen 1200, the user may activate another pull-down menu 1202 to select a trigger point that becomes a further entry to the process file 34. Trigger points may include critical dates or the occurrence of the risk contemplated.

Process templates also provide a method of specifying a standard contingency resolution for the risk that has been selected. Contingency detail is contained in the process template for the contingency, including the events and tasks which must be performed to resolve the risk. A contingency process may be created from the contingency process template and attached to the risk contingency after a process has been created.

Upon the occurrence of the contemplated risk in an actual process, the system 10 may notify the process owner (i.e., the user). The process owner may then choose to execute or not to execute the selected contingency.

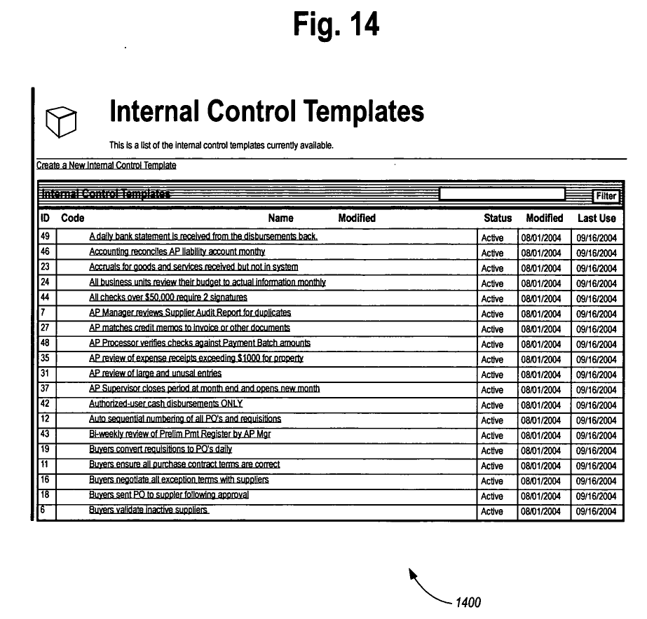

The next significant process variable is the internal control. Internal controls may be added by activating the “attach internal controls” softkey 1014 (FIG. 10). In response, the internal controls template screen 1400 of FIG. 14 may appear.

An internal control is a significant activity that is evaluated and assessed for effectiveness during the compliance process. In the hierarchy of the system 10, an internal control is a subset of requirements, one of the four process variables. However, because compliance is focused on internal control effectiveness, the system 10 treats internal controls as a primary requirement. The system 10 may also provide other requirement subsets, including inputs, outputs, policies, procedures, and process deliverables. Requirements may also include other variables at the definitional level, e.g. human and other resources, schedule of process steps and the definition of risks and contingencies.

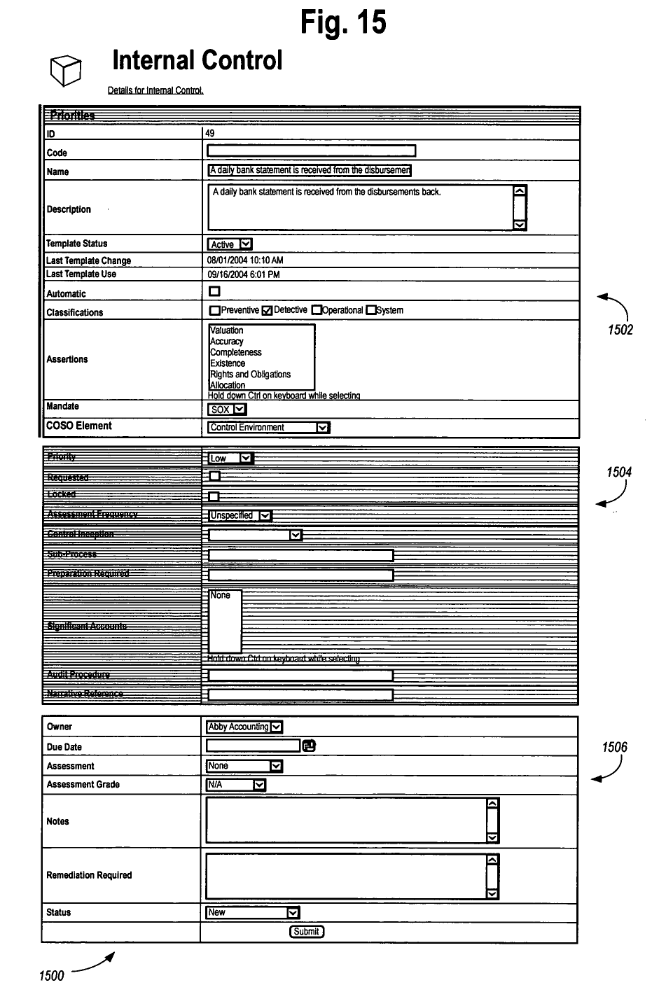

As with other screens, the user may select an Internal Control Template by placing his cursor over the description and clicking on the control template. After choosing an Internal Control Template, the user is presented with the template definition 1500 (FIG. 15) stored in the administrative definitions. Since internal controls may be common to multiple processes and multiple mandates, control templates may be put into multiple groups and attached by group to a process template or actual process. The user may edit and/or add any relevant information to define the internal control template at the process level and assign the resulting internal control to a resource for effectiveness assessment.

It should be specifically noted that the internal control template has a specific information layout that facilitates ease of use. The layout includes a first section 1502 that provide a control definition. A second section 1504 provides an operation plan and a third section 1506 provides the actual assessment of the effectiveness of the control.

In addition to user evaluation information, the internal control also includes attachments for risk, control objectives and tests. In this regard, once the user activates the submit softkey (bottom of screen 1500) and the information is added to the file 34, the user may be presented with a summary of the screen 1500 and four interactive windows for attachment of control objectives, risks, tests and documents. The four windows may have a similar appearance and operate in a similar manner to the windows 1002, 1004, 1006, 1008 of FIG. 10.

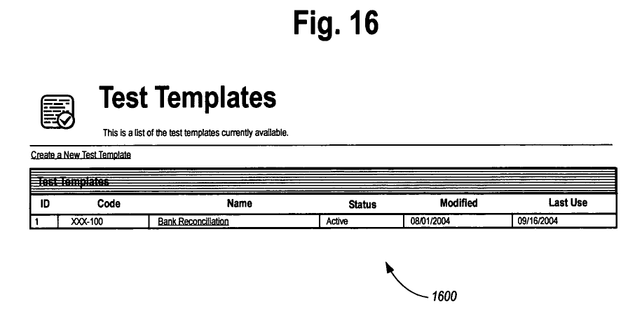

The user may activate an attach tests softkey and be presented with a list of tests in a test selection window. Within a test selection window, the user may select the test shown in FIG. 16.

In this regard, tests are also defined as templates under Admin Definitions. Tests are like tasks, but focus on the evaluation of the control to which they are attached. The system 10 defines tests at the template level as well as at the process level.

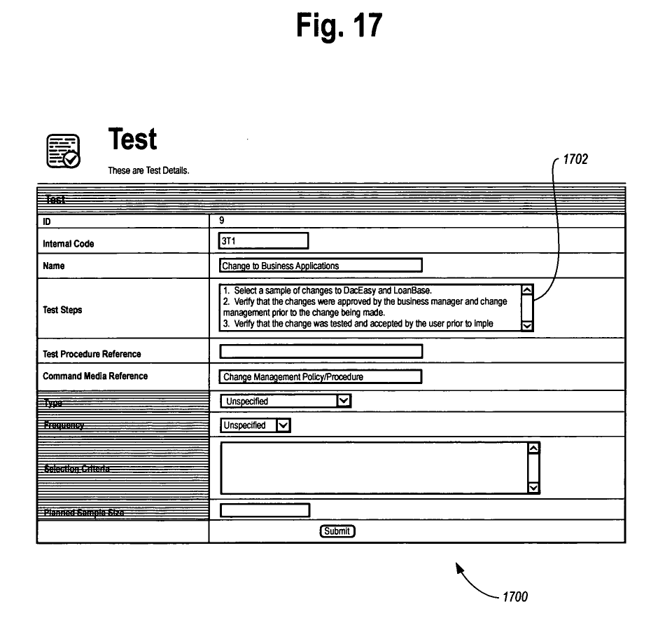

When selecting a test (FIG. 17) from the Test Templates available in the Admin Definitions, the user sees the test at the template and process level. At the process level, the user can specify the test type, frequency, selection criteria and planned sample size. However, the test is not deployed until the internal control to which it is attached actually becomes deployed as part of an active business or assessment process. At that time, the test is assigned to a user.

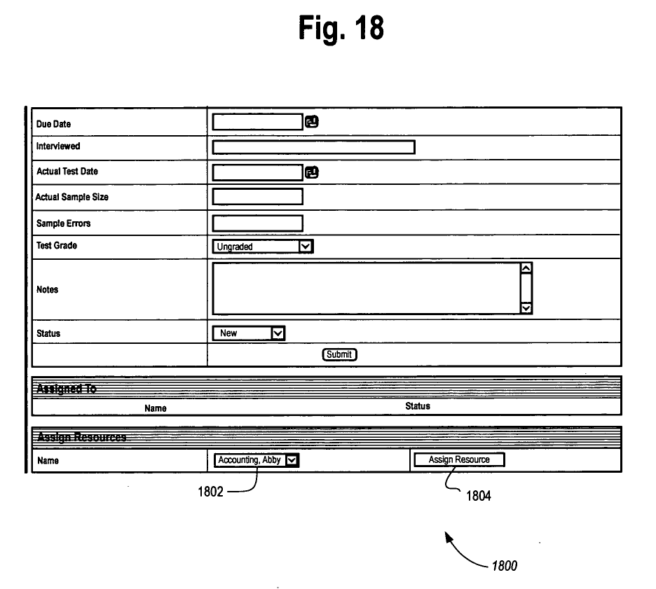

Once the submit softkey (bottom of screen 1700) is activated and the information is added to the file 34, the summary screen 1800 of FIG. 18 may be displayed. As may be noted, the test is assigned to a resource (i.e., Abby, in accounting) 1802 based upon the test steps 1702 shown in screen 1700. The user may submit this assignment by activating the assign resource softkey 1804 or select a different resource.

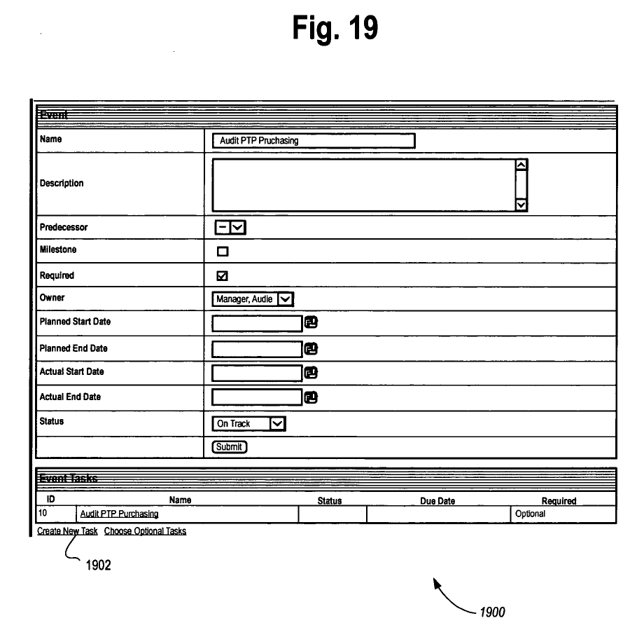

The events of a process may be defined by activation of the softkey “Create New Event” in window 1006 of FIG. 10. Activation of the Create New Event softkey allows the user to enter tasks one-at-a-time (FIG. 19) using the process definition processor 26 by activation of the Create New Task softkey 1902.

As above, events are part of the variable Schedule. The schedule consists of events, tasks and work elements necessary to complete the process. Critical to events is the specific order or “flow” of the schedule components. When creating a new event, the user works at the template level and must submit an event definition. This definition can also include the creation of specific tasks. This is another example of how the system 10 uses templates to define processes.

Like Events, Tasks are initially defined at the process template level. Events and tasks may be defined as “required” or “optional,” increasing the flexibility of the template in creation of multiple processes.

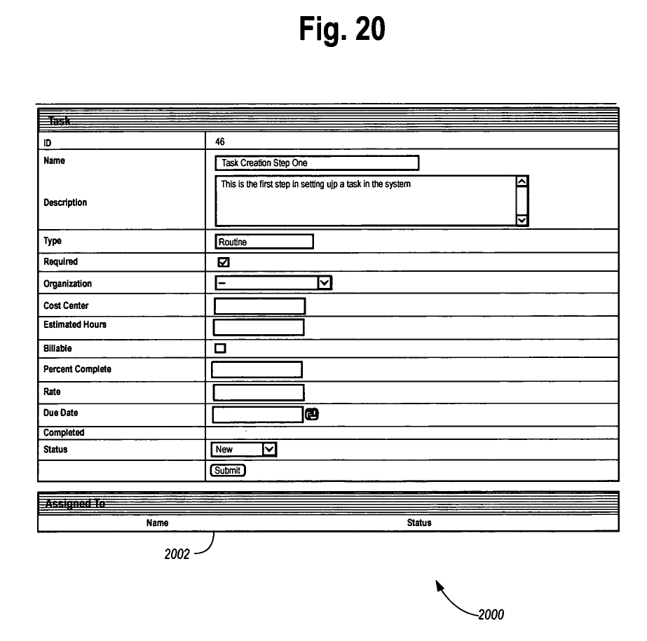

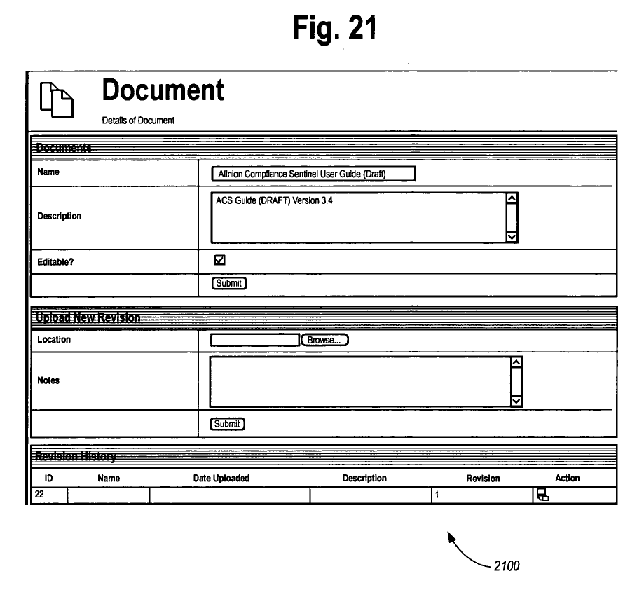

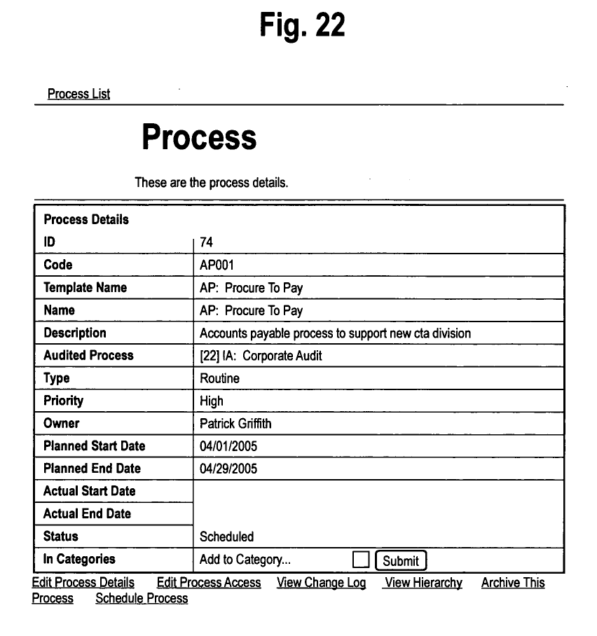

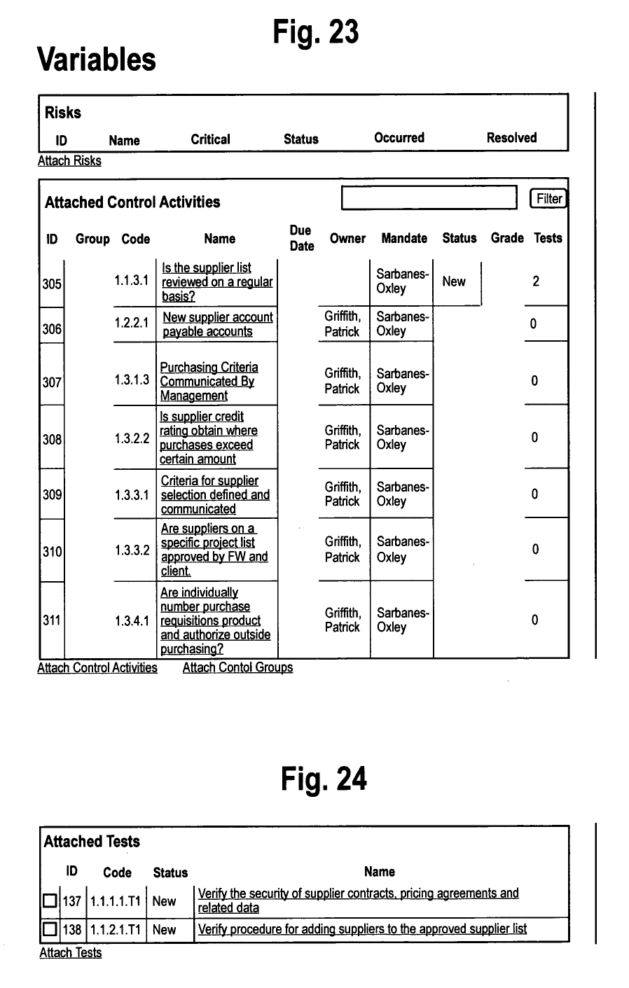

Until the process is made active, the events and tasks are kept at the template level. Once a process has been created from the process template, the user can assign ownership for both the events and tasks. FIG. 20 shows the task at the template level. Notice there is ability to assign the task to one or more resources. Because the task remains as part of a process template, assignments can only be made once the process is active.

For compliance, documents are a significant element of a process. Documents may be retrieved from an organization's standard operating procedure manual, from IRS rules or from any other source. In this regard, documents may be added by activating the Attach Documents softkey located below the documents summary 1008 (FIG. 10). The program definition processor 26 of the system 10 utilizes a Document Library for all documents that may be attached to and used within a Process. Only documents specifically made available to this process and owner may be attached. Also, when a document is defined, it is set as “read only” or for “edit.” Documents that can be edited are copied and downloaded by the user. Persons authorized to add documents to the Library can retrieve those documents from any accessible directory on an individual PC or a server within the network.

The process definition processor 26 may add the document as a program object to the internal control with which the document is to be used. The document program object may activate a viewer at the time of use to allow a person to view the document at the time of assessment of the internal control.

The system 10 allows users to manage document versions. When documents are updated, the process recognizes the new version.

Once documents have been selected and attached, the user can activate the process using a process wizard (FIG. 6). In effect, the process wizard provides an identifier of the project file 34 to the sequence processor 24 which then begins to execute the file 34. Once the template is used to create an actual process, it becomes a live process, allowing users to manage business processes against the definitions established at the template level.

It should be noted that during execution of a process, each internal control, risk, task, test or punchlist object reports into the reports generating processor 36. The reports generating processor 36 collect the notifications from the various program objects within the file 34 to generate the data shown on the dashboard 100.

In a more specific example, the purchasing director for a hypothetical organization (e.g., Control Corporation of America (CCA)) wants to establish a new audit process for tracking and reporting on the effectiveness of the Procure-To-Pay accounting process for a new corporate division. To maintain continuity and the standard accounting control methodology, the director logs onto the system 10. The director clicks on the create process selection on the navigation bar 302 of the product. The system 10 then asks the director to identify the process type (routine, project, contingency or action item). As above, these are the major process types defined in the system. Upon choosing a process type (the director chooses “Routine”), the system offers the pre-defined process templates already contained in the administration definition section 306 of Process Templates. These templates are stored in the system libraries and may have been developed and deployed for other operating divisions within the company.

The Purchasing Director then identifies a specific pre-existing process template (i.e., AP: Procure to Pay) and clicks the submit button 908. Generated on screen is the Process Template Definition for the AP Procure to Pay Process. The Purchasing Director completes the process by identifying the specific owner of the process (Patrick Griffith, FIG. 22), the start and end dates (Apr. 1, 2005 and Apr. 29, 2005), establishes a priority for the process (high), chooses a parent process and the audited process (corporate audit) to which this process shadows.

Upon clicking the submit button, the Purchasing Director then views the summary screen 1000 through which the director selects and may modify the process variables that will determine the process outcome in terms of effectiveness. Variables include Risks, Controls and Events. Risks are pre-defined gaps between anticipated process outcome and the risks that would occur if the process effectiveness is not completed as defined, including timeline. Risks are pre-defined and stored in the library 20, 22 and were attached to the process template prior to the creation of this process. The Purchasing director selects and modifies the two risks—Missed Start Date and Missed Assessment Date—to apply specifically to this actual process. Risk details can be view by clicking on the selected risk. Details for the risk are presented in the unique “Define, Operate and Audit” Paradigm of the system 10.

The following seven internal control templates were attached to the process template and are now part of this process: 1) Is the supplier list reviewed on a regular basis?; 2) New supplier account payable accounts; 3) Purchasing Criteria Communicated By Management; 4) Is supplier credit rating obtained where purchases exceed certain amount?; 5) Criteria for supplier selection defined and communicated?; 6) Are suppliers on a specific project list approved by CCA? and 7) Are individually numbered purchase requisitions produced and authorized outside Purchasing? (see FIG. 23.) The user has the option of deleting any control or adding a new control, unless the controls were “locked” during the template definition. (Due to the mandate requirements of internal controls, the system 10 provides the option of locking an internal control definition at the process template level to ensure proper definition and compliance).

Once attached to the process, the control template is activated for deployment and assessment. The Control Activity is listed in the summary screen under the variables attached to the AP—Procure to Pay. The purchasing director or the assigned process owner must then complete the definition of each control activity within the confines of the templates. Attributes are added to the control definition at the process template level, including assertions, classifications, mandates and elements. If not locked, they may be modified at the process level. For the control operation, the Purchasing Director selects operation attributes, including frequency, priority, significant accounts and pertinent audit procedures and narrative references. The final aspect of the control resides in its assessment program, which allows the appropriate resource to assess control effectiveness against the operational plan and definition.

The Purchasing Director can also attach documents from the library 20, 22, test templates (represented in the same Define, Operate and Assess format), risks and Control Objectives. Each element supports the effectiveness assessment of the control. The pre-existing Control Template already includes specific tests to assure and support standard evaluation methodologies. For example, the test “Verify the security of supplier contracts, pricing agreements and related data” may be a pre-existing test used by CCA in connection with the pre-existing template “Procedure to pay”. If the director should click on this entry within the test summary, then the specific definition screen for this test may be displayed. In this screen, the test may be shown to include the pre-defined steps of: 1) Verify that physical location of documents is locked and that only authorized personnel have access and 2) Verify that electronic documents are kept in a secure directory, accessible by authorized login and password only. The test may be assigned to resource, Jane. If the defined process does not detect entry of assessment data from Jane by the due date, then the process may send an alert to the process owner. Assessment grading may also be amalgamated to the dashboard and represented to users within the system as assignments and in status format.

The final variable the Purchasing Director must complete through definition is Events and the supporting tasks required to complete the Event Variable. In the system 10, events are pre-defined processes containing a series of tasks. Each task defines a specific activity that must be completed within a specific timeline during the assessment period. The system 10 assigns activities through the selection of resources for each task. Assignments are posted to the assignee (resource) dashboard as well as to the process owner dashboard. Status is tracked and monitored by the system 10 and represented on the dashboard. Once the event is defined, the event is submitted and represented as a variable to the process outcome. For this AP-Procure to Pay Process, the Purchasing Director establishes events and tasks that are required to accomplish the audit process. For this process, three events have been identified: 1) prepare to Audit Procure To Pay; 2) conduct Sampling and Testing and 3) record and Submit Results.

For each event, a series of tasks have been defined and identified. Tasks are attached to the event definition. For the Prepare to Audit Procure to Pay event, the task “Procure To Pay Audit Preparation” has been defined. The definition includes an overall description of task steps, organizational identification, Billing Centers, rates, estimated hours, due dates, and status. In addition, task definition includes resource identification and supporting documents.

Within the system 10, testing is a type of task. For organization purposes, a test is attached directly to a control activity (which includes testing as the task used to determine the control grade). The test contains similar information as does the task, allowing users to attach documentation links as proof of results.

In addition to Risks, Controls and Events, the system 10 also defines and tracks requirements. Requirements are specific issues that must be completed according to definition. An example of a requirement may be found in a purchasing contract between the CCA Company and its vendor. The requirement may also affect process outcome.

The Process is also further defined by documents (already covered), Punchlists and Notes. A Punchlist is an action item that is not part of the control or process definition and can be used to initiate a remediation action or special assignment within the process. A primary design goal for the system 10 is to integrate all communications regarding a process within the product and providing a completely auditable trail for auditors, regulators and other interested parties to examine in an organized fashion. Punchlists and notes keep all communication within the system, obviating the need to create or collect external documentation and communication to support audit or assessment inquiry.

When the Purchasing Director has completed the definitional elements of the Process Definition, the process is automatically deployed into the enterprise. Based on how the administrative definitions have been set up, the system 10 automatically assigns work to the identified resources and provides real-time status of tracking as the process works it way through the assessment period.

In this use case, the Purchasing Director has defined a process (AP-Procure to Pay) and then deployed it using the standard definitions of the templates contained within the system but also enhancing the definition through attributes or components stored in the system archive. The benefit to CCA is a standard and auditable process focused purely on the effectiveness evaluation, not on extraneous issues such as efficiency. Process definition is completed through the unique capability of creating one-to-one, one-to-many or many-to-many relationships between components without the use of standard linear workflow. In addition, the components are represented to the user in a unique way that promotes definition and deployment quickly and efficiently.

A specific embodiment of a method and apparatus for defining and monitoring a process of an organization has been described for the purpose of illustrating the manner in which the invention is made and used. It should be understood that the implementation of other variations and modifications of the invention and its various aspects will be apparent to one skilled in the art, and that the invention is not limited by the specific embodiments described. Therefore, it is contemplated to cover the present invention and any and all modifications, variations, or equivalents that fall within the true spirit and scope of the basic underlying principles disclosed and claimed herein.

1. A method of defining and monitoring a process of an organization, such method comprising:
selecting a process template for tracking the process from a plurality of pre-existing templates where the selected process template is a process selected from the group consisting of routine processes, project processes and action item processes;
defining a schedule of events and tasks that define the process;
selecting an internal control of the organization for assessing the effectiveness of at least one event of the defined schedule of events; and
defining and monitoring the at least one event for completion in compliance with a predetermined criteria of the internal control.

2. The method of defining and monitoring the process as in claim 1 wherein the step of selecting an internal control further comprises selecting the internal control from a plurality of pre-existing internal control templates.

3. The method of defining and monitoring the process as in claim 2 further comprising assigning a resource to the internal control for ownership and/or assessment.

4. The method of defining and monitoring the process as in claim 2 wherein the step of defining and monitoring the at least one event for completion under the predetermined criteria further comprises testing the internal control.

5. The method of defining and monitoring the process as in claim 4 wherein the step of testing further comprises selecting the test from a pre-existing plurality of tests.

6. The method of defining and monitoring the process as in claim 5 wherein the assigned resource further comprises a person evaluating the at least one internal control based upon the selected test.

7. The method of defining and monitoring the process as in claim 6 further comprising assigning a document to the internal control that defines the predetermined criteria and/or results evaluated under the selected test.

8. The method of defining and monitoring the process as in claim 1 further comprising selecting a risk associated with failure of the process from a pre-determined plurality of risks.

9. The method of defining and monitoring the process as in claim 8 wherein the step of selecting a risk further comprises selecting a contingency plan from a plurality of pre-determined contingency plans for addressing the risk.

10. The method of defining and monitoring the process as in claim 9 further comprising assigning a resource to each selected contingency plan.

11. The method of defining and monitoring the process as in claim 1 wherein the step of defining and monitoring the at least one event further comprises notifying a person responsible for the process when the monitored event has not been completed in compliance with the criteria.

12. An apparatus for defining and monitoring a process of an organization, such apparatus comprising:
means for selecting a process template for defining, executing and tracking the process from a plurality of pre-existing templates where the selected process template is a process selected from the group consisting of routine processes, project processes and action item processes;
means for defining a schedule of events that define the process;
means for selecting an internal control of the organization for assessing the effectiveness of at least one event of the defined schedule of events; and
means for defining and monitoring the at least one event for completion in compliance with a predetermined criteria of the internal control.

13. The apparatus for defining and monitoring the process as in claim 12 wherein the means for selecting an internal control further comprises means for selecting the internal control from a plurality of pre-existing internal control templates.

14. The apparatus for defining and monitoring the process as in claim 13 further comprising means for assigning a resource to the internal control.

15. The apparatus for defining and monitoring the process as in claim 13 wherein the means for defining and monitoring the at least one event for completion under the predetermined criteria further comprises means for testing the event.

16. The apparatus for defining and monitoring the process as in claim 15 wherein the means for testing further comprises means for selecting the test from a pre-existing plurality of tests.

17. The apparatus for defining and monitoring the process as in claim 16 wherein the assigned resource further comprises a person evaluating the at least one event based upon the selected test.

18. The apparatus for defining and monitoring the process as in claim 16 further comprising means for assigning a document to the internal control that defines the predetermined criteria.

19. The apparatus for defining and monitoring the process as in claim 12 further comprising means for selecting a risk associated with failure of the process from a pre-determined plurality of risks.

20. The apparatus for defining and monitoring the process as in claim 19 wherein the means for selecting a risk further comprises means for selecting a contingency plan from a plurality of pre-determined contingency plans for addressing the risk.

21. The apparatus for defining and monitoring the process as in claim 20 further comprising means for assigning a resource to each selected risk.

22. The apparatus for defining and monitoring the process as in claim 12 wherein the means for defining and monitoring the at least one event further comprises means for notifying a person responsible for the process when the monitored event has not been completed in compliance with the criteria.

23. An apparatus for defining and monitoring a process of an organization, such apparatus comprising:
a process templates interactive screen adapted to allow selection of a process template for tracking the process from a plurality of pre-existing templates where the selected process template is a process selected from the group consisting of routine processes, project processes and action item processes;
an events interactive screen adapted to define a schedule of events that define the process;
an internal control interactive screen adapted to allow selection of an internal control of the organization for assessing the effectiveness of at least one event of the defined schedule of events; and
a dashboard screen adapted to monitor the at least one event for completion in compliance with a predetermined criteria of the internal control.

24. The apparatus for defining and monitoring the process as in claim 23 wherein the interactive internal control screen further comprises an interactive screen adapted to select the internal control from a plurality of pre-existing internal control templates.

25. The apparatus for defining and monitoring the process as in claim 24 further comprising a resource window adapted to assign a resource to the internal control.

26. The apparatus for defining and monitoring the process as in claim 24 wherein the dashboard further comprises a test processor adapted to test the process.

27. The apparatus for defining and monitoring the process as in claim 26 wherein the test processor further comprises a test selection screen adapted to select the test from a pre-existing plurality of tests.

28. The apparatus for defining and monitoring the process as in claim 27 wherein the assigned resource further comprises a person evaluating the at least one event based upon the selected test.

29. The apparatus for defining and monitoring the process as in claim 27 further comprising a document screen adapted to assign a document to the internal control that defines the predetermined criteria.

30. The apparatus for defining and monitoring the process as in claim 23 further comprising a risk selection screen adapted to select a risk associated with failure of the process from a pre-determined plurality of risks.

31. The apparatus for defining and monitoring the process as in claim 30 wherein the risk selection screen further comprises a contingency selection screen adapted to select a contingency plan from a plurality of pre-determined contingency plans for addressing the risk.

32. The apparatus for defining and monitoring the process as in claim 31 further comprising a resource screen adapted to assign a resource to each selected risk.

33. The apparatus for defining and monitoring the process as in claim 23 wherein the dashboard screen further comprises a visual display adapted to notify a person responsible for the process when the monitored event has not been completed in compliance with the criteria.

34. A method of defining and monitoring a process comprising:
defining a set of internal controls of the process;
identifying any resources of the process;
defining a schedule of events where each event of the plurality of events delineates application of at least one internal control to at least one resource of the plurality of resources; and
defining and monitoring the schedule for completion of each event under the process.

35. A method of defining and monitoring a process comprising:
defining a set of internal controls of the process;
identifying any resources of the process;
defining a schedule of events where each event of the plurality of events delineates application of at least one internal control to at least one resource of the plurality of resources; and
defining and monitoring the schedule for completion of each event under the process.

36. A method of defining and monitoring a process comprising:
defining a set of internal controls of the process;
identifying any resources of the process;
providing a schedule of events under which at least some of the internal controls are applied to at least some of the identified resources under the process;
defining and monitoring events of the schedule of events for a predetermined risk associated with an event of the schedule of events; and
assigning a predefined contingency task upon the occurrence of the predetermined risk.
